(19) United States
(12) Patent Application Publication
(10) Pub. No.: US 2012/0157654 A1
(43) Pub. Date: Jun. 21, 2012

(54) METHOD FOR THE DRYING AND POST-CONDENSATION OF POLYAMIDE PARTICLES

(75) Inventors: Faissal-Ali El-Toufaili, Ludwigshafen (DE); Achim Stammer, Freinsheim (DE); Jens Becker, Eisenberg (DE); Karsten Daunke, Lambrecht (DE); Thomas Sauer, Dirmstein (DE)

(73) Assignee: BASF SE, Ludwigshafen (DE)

(21) Appl. No.: 13/315,392

(22) Filed: Dec. 9, 2011

Related U.S. Application Data
(60) Provisional application No. 61/424,083, filed on Dec. 17, 2010.

(51) Int. Cl. C08G 69/46; C08G 69/14

(52) U.S. Cl. 528/326

(57) ABSTRACT

Method for the drying and post-condensation of polyamide particles, wherein the polyamide particles are irradiated with electromagnetic waves while passing an inert gas through the particles.

The present invention relates to a method for the drying and post-condensation of polyamide particles, which comprises irradiation with electromagnetic waves.

EP-A-1 235 671 discloses a method for the drying and post-condensation of polyamide pellets, in which drying is carried out in a crossflow apparatus and post-condensation is subsequently carried out in a shaft apparatus in a gentle countercurrent of nitrogen. A disadvantage of this method is the slow introduction of heat.

EP-A-732 351 discloses a method of producing polyamides, in which the polyamide pellets are dried and post-condensed in a two-stage heat treatment up to about 10° C. below the melting point. A disadvantage of this method is the low space-time yield.

It is therefore an object of the present invention to remedy the abovementioned disadvantages.

We have accordingly found a novel and improved method for the drying and post-condensation of polyamide particles, wherein the polyamide particles are irradiated with electromagnetic waves while passing an inert gas through the particles.

The method of the invention can be carried out as follows:

The polyamide particles can be irradiated batchwise or preferably continuously under a stream of inert gas at temperatures of from 10 to 200° C., preferably from 15 to 150° C., particularly preferably from 18 to 80° C., particularly preferably from 20 to 40° C., and a pressure of from 0.01 to 10 bar, preferably from 0.1 to 7 bar, particularly preferably from 0.9 to 5 bar, in particular at atmospheric pressure, with electromagnetic waves in the range from 300 MHz to 300 GHz, preferably from 600 MHz to 50 GHz, particularly preferably from 750 MHz to 5 GHz, in particular 2.45 GHz (+/−10%) or 915 MHz (+/−10%), known as microwaves. In general, it is advantageous to set the conditions so that the polyamide particles do not agglomerate, aggregate, conglobate, form lumps, become plastic, become liquid or become gaseous. The treatment time can be varied within wide limits and is generally from 0.1 to 500 h, preferably from 0.2 to 50 h, particularly preferably from 0.3 to 20 h.

The method of the invention can in one or more connected or preferably separate reaction spaces, i.e. from 2 to 10, for example, 2, 3, 4, 5, 6, 7, 8, 9 or 10, preferably from 2 to 5, for example 2, 3, 4 or 5, particularly preferably 2 or 3, in particular 2, reaction spaces, preferably one or 2 reaction spaces.

For the purposes of the present invention, reaction spaces are spaces which are present, for example, in reactors and dryers.

Suitable polyamide particles for the method of the invention are particles having any shape, for example granules, pellets, grains, spheres, platelets.

The polyamide particles used in the method of the invention can be produced by methods known per se (for example as described in EP-B-1 235 671, EP-B-732 351, EP-A-348 821, EP-A-702 047 and EP-A-284 968). These polyamide particles generally have a content of residual oligomers in the range from 0.3 to 20% by weight, preferably from 0.35 to 15% by weight, particularly preferably from 0.4 to 2.5% by weight, and a content of residual monomers of less than or equal to 15% by weight, i.e. from 0.001 to 15% by weight, preferably from 0.1 to 12% by weight, particularly preferably from 8 to 10% by weight, and a moisture content of from 0.1 to 30% by weight, preferably from 3 to 15% by weight.

The size of the polyamide particles can be varied within a wide range and the diameter of the particles is generally from 0.1 to 10 mm, preferably from 0.2 to 5 mm, particularly preferably from 1 to 4 mm, in particular from 2 to 3 mm.

Suitable polyamides are any polyamides, for example polyamide-6, polyamide-11, polyamide-12, polyamide-7, polyamide-8, polyamide-9, polyamide-10, or copolyamides and also mixtures of aliphatic and (partially)aromatic (co)polyamides, preferably polyamide-6 and polyamide-12, particularly preferably polyamide-6.

Suitable inert gases are all gases which are inert under the conditions of the method, e.g. nitrogen, helium, argon, carbon monoxide, carbon dioxide, steam or mixtures thereof, preferably nitrogen, carbon monoxide, carbon dioxide and steam or mixtures thereof, particularly preferably nitrogen.

The method of the invention can be carried out in suitable apparatuses as are generally known and are described, for example, in EP-A-1 235 671. Suitable apparatuses are, for example, shafts, e.g. with moving bed, fluidized bed and/or pulsed bed, crossflow dryers, shaft dryers, belt dryers or fluidized-bed dryers and an electromagnetic radiation source. The dryers can be followed by a cooling facility such as a cooling apparatus. Suitable geometries of the apparatuses are indicated in EP-A-1 235 671 in the description and in the drawings.

Particular preference is given to carrying out the method using an active shaft which has an additional inert gas circuit, as is known from EP-B-1 235 671 paragraphs [0032] to [0037].

Irradiation can preferably be carried out directly in a dryer provided with, for example, a window which is transparent to electromagnetic radiation, e.g. a window made of fused silica or Teflon. Suitable dryers are shaft dyers supplied with an inert gas or steam in countercurrent or cocurrent, crossflow dryers, fluidized-bed dryers or belt dryers.

From 5 to 100%, preferably from 6 to 90%, particularly preferably from 8 to 80%, in particular from 10 to 70%, of the energy required for the method of the invention can come from electromagnetic energy.

The inert gas introduced for drying and/or post-condensation can be discarded and is generally recirculated, preferably directly, particularly preferably after a work-up, either in its entirety, i.e. to an extent of 100%, or preferably partly, i.e. to an extent of from 5 to 99.9% by volume, preferably from 20 to 99.5%, particularly preferably from 30 to 99.3%, in particular from 50 to 99%, in the method of the invention.

After drying of the polyamide particles by irradiation with electromagnetic waves while passing an inert gas through the particles, the polyamide particles can be treated with inert gas or steam or mixtures thereof at temperatures of from 70 to 250° C., preferably from 90 to 210° C., particularly preferably from 100 to 180° C., and a pressure of from 0.01 to 10 bar, preferably from 0.1 to 7 bar, particularly preferably from 0.9 to 5 bar, in particular at atmospheric pressure.

In this way, it is possible to produce polyamide particles having a viscosity number of from 100 to 400 mg/l, preferably from 110 to 300 ml/g, particularly preferably from 115 to 250 ml/g, and a monomer content of from 0.001 to 5% by weight, preferably from 0.01 to 1% by weight, particularly preferably from 0.02 to 0.08% by weight, and an average molecular weight of from 1000 to 500000 g/mol, preferably from 5000 to 200000 g/mol, particularly preferably from 10000 to 50000 g/mol, and an oligomer content of from 0.001 to 10% by weight, preferably from 0.05 to 1% by weight, particularly preferably from 0.1 to 0.5% by weight.

The adjustment of the viscosity can be effected, inter alia, by the temperatures employed and residence time. In general, high viscosities and higher molecular weights are achieved at higher temperatures.

The polyamide particles which have been treated according to the invention are suitable for producing packaging films, fibers, automobile parts, electric and electronic components and fishing nets.

### EXAMPLES

### Example 1

Production of polyamide-6 pellets as described in DE-A-43 21 683, Example 1

From a heated pump reservoir having a temperature of 80° C., 20.4 l/h of caprolactam melt having a water content of 2% by weight were fed by means of a pump, with nitrogen flushing at 15 a pressure of 1050 mbar, into a heated heat exchanger having an exchange area of 6 m² and an inlet temperature of 270° C. and heated over a period of 2 minutes to a temperature of 260° C. The pressure at the pressure side of the pump was 15 bar; the feed was a single-phase liquid. The feed solution was pumped continuously through a cylindrical tube having a length of 5000 mm and an 20 internal diameter of 130 mm and filled with 5 mm Raschig rings having a web, with the average residence time being 2.5 h. The cylindrical tube was heated to 270° C. by means of a heat transfer oil. The product temperature at the end of the tube was 270° C. The pressure at which the reaction mixture was still a single-phase liquid was 10 bar. The product taken off under pressure at the end of the cylindrical tube had the following 25 analytical data:

Viscosity number (measured as 0.55% strength by weight solution in 96% strength by weight sulfuric acid)=57 ml/gj of acid end groups=157 mmol/kgj of amino end groups=155 mmol/kg; extract=10.5%; melt viscosity (single-phase liquid under super-atmospheric pressure at 270° C. in a rotational viscosimeter)=280 mPa·s. The reaction mixture was continuously depressurized to a pressure of 30 atmospheres via a regulating valve into a protectively heated separation vessel, with the reaction mixture becoming a two-phase mixture and the temperature being decreased by 8° C. to 262° C. as a result of adiabatic evaporation of water. A molten prepolymer having the following analytical data was obtained at the bottom of the separation vessel: viscosity number (measured as 0.55% strength by weight solution in 96% strength by weight sulfuric acid)=81 ml/gj of acid end groups=99 mmol/kgj of amino end groups=102 mmol/kg; extract=9.7%; melt viscosity (270° C.)=350 mPa·s. The gaseous vapor comprised 70% by weight of water and 30% by weight of steam-volatile components (the determination of the composition was carried out by determining the refractive index of the lactam present in the condensate at 25° C., using a calibration curve with various caprolactam/water ratios as a basis) and was discharged at the top of the separation vessel, then liquefied in a condenser and subsequently used for preparing the starting mixture.

After a residence time of 5 minutes, the prepolymer was discharged continuously by means of a melt pump from the separation vessel through a die into a water bath in the form of melt profiles, solidified in the water bath and pelletized. The prepolymer prepared in this way was subsequently extracted with water in countercurrent using a method analogous to the prior art (see DD-A 206999) and heated until a molecular weight of 28500 g/mol had been reached.

The polyamide-6 pellet produced in this way had the following properties:

TABLE 1

| REC | VN | RMC |
|---|---|---|
| [%] | [ml/g] | [%] |
| 0.3 | 122 | 14.9 |

Abbreviations:

RMC=residual moisture content

REC=residual extract content (sum of caprolactam and oligomers)

VN=viscosity number

### Examples 2 and 3

30 l/h of nitrogen were passed through 16.8 g of the polyamide pellets produced in example 1 on a glass frit in a microwave drying apparatus (designation: SMART System 5) from CEM GmbH while treating the pellets with the microwave power and for the irradiation time showed in Table A.

The results are shown in Table A.

The residual moisture content of the polyamide samples was determined in a Karl Fischer apparatus (coulometric determination) (Analytica Chimica Acta, Volume 81, Issue 2, February 1976, pages 231-263).

The water was driven off at 200° C. by means of nitrogen and determined.

To determine the viscosity number (VN), 0.5 g of the purified polyamide pellets were dissolved in 96±0.1% strength sulfuric acid to give a solution having a concentration of 0.5% (m/v). In an Ubbelohde viscosimeter, the running-through times of the sample solution and of the solvent were determined at a water bath temperature of 25.0±0.05° C. and the viscosity number or the relative viscosity was calculated therefrom.

The results are shown in Table A.

TABLE A

| Microwave | | | Residual moisture | |
|---|---|---|---|---|
| power* | Irradiation time | Temperature | content | VN |
| [watt] | [min] | [° C.] | [% by weight] | [ml/g] |
| — | — | — | 14.9 | 122 |
| 300 | 30 | 140 | 7.1 | 128 |
| 500 | 30 | 140 | 6.2 | 129 |

*microwave power = power of the microwave radiation in watt

1-6. (canceled)

7. A method for the drying and post-condensation of polyamide particles which comprises irradiating the polyamide particles with electromagnetic waves while passing an inert gas through the particles.

8. The method for the drying and post-condensation of polyamide particles according to claim 7, wherein the polyamide particles are treated under a stream of inert gas with electromagnetic waves in the range from 300 MHz to 300 GHz.

9. The method for the drying and post-condensation of polyamide particles according to claim 7, wherein the polyamide particles are treated under a stream of inert gas at temperatures of from 10 to 200° C.

10. The method for the drying and post-condensation of polyamide particles according to claim 7, wherein the polyamide particles are treated under a stream of inert gas at a pressure of from 0.01 to 10 bar.

11. The method for the drying and post-condensation of polyamide particles according to claim 7, wherein the treatment is carried out continuously under a stream of inert gas.

12. The method for the drying and post-condensation of polyamide particles according to claim 8, wherein the polyamide particles are treated under a stream of inert gas at temperatures of from 10 to 200° C.

13. The method for the drying and post-condensation of polyamide particles according to claim 12, wherein the polyamide particles are treated under a stream of inert gas at a pressure of from 0.01 to 10 bar.

14. The method for the drying and post-condensation of polyamide particles according to claim 13, wherein the treatment is carried out continuously under a stream of inert gas.

15. A process for producing packaging films, fibers, automobile parts, electric components, electronic components or fishing nets which comprises utilizing the polyamide particles according to claim 7.
